(19) United States
(12) Patent Application Publication
(10) Pub. No.: US 2019/0220021 A1
(43) Pub. Date: Jul. 18, 2019

(54) TRAVEL TRAJECTORY DETERMINATION SYSTEM AND AUTOMATIC DRIVING SYSTEM

(71) Applicant: HONDA MOTOR CO., LTD., Tokyo (JP)

(72) Inventors: Yuji Yasui, Wako-shi (JP); Hideki Matsunaga, Wako-shi (JP)

(73) Assignee: HONDA MOTOR CO., LTD., Tokyo (JP)

(21) Appl. No.: 16/242,402

(22) Filed: Jan. 8, 2019

(30) Foreign Application Priority Data
Jan. 12, 2018 (JP) 2018-003309

(51) Int. Cl. G05D 1/02; B60W 40/072; B60W 30/18

(52) U.S. Cl. CPC G05D 1/0212; B60W 30/18154; B60W 40/072

(57) ABSTRACT

A travel trajectory determination system 1 includes an ECU. The ECU acquires a second road target point Xt0, determines an arc Ar between two inner contact points Xi and Xo of a circle IC inscribed in a first straight line L1 extending from a vehicle in a traveling direction of the vehicle while passing through an intersection, and a second straight line L2 extending in such a manner as to intersect with the first straight line L1 in the intersection while passing through the second road target point Xt0, and determines a future travel trajectory Xf of the vehicle by use of the arc Ar.

### CROSS REFERENCES TO RELATED APPLICATIONS

The present application claims priority under 35 U.S.C. § 119 to Japanese Patent Application No. 2018-003309, filed Jan. 12, 2018, entitled “ TRAVEL TRAJECTORY DETERMINATION SYSTEM AND AUTOMATIC DRIVING SYSTEM.” The contents of this application are incorporated herein by reference in their entirety.

### TECHNICAL FIELD

The present disclosure relates to a travel trajectory determination system and an automatic driving system that determine a future travel trajectory of a vehicle when the vehicle travels on a bending road.

### BACKGROUND

Heretofore, as a travel trajectory system for determining a travel trajectory when a vehicle travels on a bending road, a navigation system type described in Japanese Patent Application Publication No. 2012-2753 has been known. A travel trajectory determination system shown in FIG. 7 of the document includes a storage part and a controller, and the storage part includes a map database, a trajectory curve file, and a road network database.

In the travel trajectory determination system, as shown in FIG. 8 of the document, current location information is acquired, and it is determined whether the vehicle is turning in the vicinity of an intersection in road network data on the basis of the current location information. If it is determined that the vehicle is turning, a travel trajectory curve during travel through the intersection is determined. Specifically, if a travel trajectory curve corresponding to an entry link and an exit link to the intersection is stored in the trajectory curve file, the travel trajectory curve is read out. On the other hand, if a corresponding travel trajectory curve is not stored in the trajectory curve file, a trajectory curve contacting the entry link and the exit link is generated.

### SUMMARY

According to the above conventional travel trajectory determination system, the travel trajectory curve is determined by use of the road network data. Accordingly, there is a problem that if data of an intersection into which the vehicle is entering does not exist in the road network data, it is impossible to determine whether the vehicle is turning in the vicinity of the intersection, or to determine the travel trajectory curve. In this case, while road environment changes by construction and the like, there are limitations to keeping up with the changes and constantly updating the road network data to the latest state. As a result, the above problems inevitably occur in the travel trajectory determination system of Japanese Patent Application Publication No. 2012-2753.

Thus, it is preferable to provide a travel trajectory determination system and an automatic driving system including the system, that can appropriately determine a future travel trajectory when a vehicle travels on a bending road, even under conditions where data storing road environment and the like does not exist.

On aspect of the present disclosure is a travel trajectory determination system 1 in which a future travel trajectory Xf of a vehicle 3 is determined when the vehicle 3 travels from a first road 51 toward a second road 52 continuous with and bending with respect to the first road 51, the system including: second road target point acquisition means (ECU 2, travel environment calculator 10) that acquires a second road target point Xt0 as a target in the second road 52; arc determination means (ECU 2, evaluation function value calculator 20, radius calculator 30, travel trajectory calculator 40) that determines an arc Ar between two inner contact points Xi and Xo of a circle IC inscribed in a first straight line L1 extending from the vehicle 3 in a traveling direction of the vehicle 3 while passing through a continuous part (intersection 50) of the first road 51 and the second road 52, and a second straight line L2 extending in such a manner as to intersect with the first straight line L1 in the continuous part (intersection 50) while passing through the second road target point Xt0, the arc determination means determining the arc Ar such that the arc Ar is at least included in the continuous part (intersection 50); and travel trajectory determination means (ECU 2, travel trajectory calculator 40) that determines the future travel trajectory Xf of the vehicle 3 by use of the arc Ar.

According to the above travel trajectory determination system, the arc between two inner contact points of a circle inscribed in a first straight line extending from the vehicle in a traveling direction of the vehicle while passing through a continuous part of the first road and the second road, and a second straight line extending in such a manner as to intersect with the first straight line in the continuous part while passing through the second road target point, is determined such that the arc is at least included in the continuous part. The future travel trajectory of the vehicle is determined by use of the arc. Hence, the future travel trajectory of the vehicle may be determined as a trajectory formed only of the arc, or a trajectory smoothly connecting the arc and straight lines. As a result, a smooth trajectory with no drifting to the right or left as in the case of driving by a well-experienced driver, can be determined as the future travel trajectory of the vehicle when it travels from the first road toward the second road continuous with and bending with respect to the first road (note that “acquire” as in “acquire the second road target point” in the specification is not limited only to direct detection by a sensor or the like, and includes calculation/ assumption thereof).

Another aspect of the present disclosure preferably further includes travel target point acquisition means (ECU 2, travel environment calculator 10) that acquires a travel target point Xc as a target when the vehicle 3 stops in the continuous part (intersection 50) or passes through the continuous part (intersection 50), and the arc determination means preferably determines the arc Ar such that the arc Ar gradually approaches the travel target point Xc.

According to the above travel trajectory determination system, the travel target point as a target when the vehicle stops in the continuous part or passes through the continuous part is acquired, and the arc is determined so as to gradually approach the travel target point. Hence, the future travel trajectory of the vehicle can be determined appropriately, so that the vehicle may stop in the vicinity of the travel target point or pass the vicinity of the travel target point when the vehicle travels through the continuous part.

Another aspect of the present disclosure preferably further includes travel target point acquisition means (ECU 2, travel environment calculator 10) that acquires a travel target point Xc as a target when the vehicle 3 stops in the continuous part (intersection 50) or passes through the continuous part (intersection 50), and the arc determination means preferably determines the arc Ar such that, of a distance Dc between the arc Ar and the travel target point Xc, a first length (line segment Li) which is a length of the first straight line L1 from the vehicle 3 to the inner contact point Xi of the arc Ar, and a second length (line segment Lo) which is a length of the second straight line L2 from the inner contact point Xo of the arc Ar to the second road target point Xt0, reduction of the distance Dc is prioritized over reduction of the first length (line segment Li) and the second length (line segment Lo).

According to the above travel trajectory determination system, the travel target point as a target when the vehicle stops in the continuous part or passes through the continuous part is acquired, and the arc is determined such that, of a distance between the arc and the travel target point, a first length which is a length of the first straight line from the vehicle to the inner contact point of the arc, and a second length which is a length of the second straight line from the inner contact point of the arc to the second road target point, reduction of the distance is prioritized over reduction of the first length and the second length. Hence, the arc can be determined such that its curvature is preferentially enlarged. Accordingly, when the vehicle travels through the continuous part, the future travel trajectory of the vehicle can be determined appropriately, so that the vehicle can stop in the vicinity of the travel target point or pass the vicinity of the travel target point while suppressing lateral acceleration.

In another aspect, in a case where the vehicle 3 travels from the first road 51 toward the second road 52, when the travel target point Xc cannot be acquired by the travel target point acquisition means, the arc determination means preferably determines the arc Ar such that the first length (line segment Li) and the second length (line segment Lo) are made shorter than when the travel target point Xc is acquired.

According to the above travel trajectory determination system, in a case where the vehicle travels from the first road toward the second road, when the travel target point cannot be acquired by the travel target point acquisition means, the arc is determined such that the first length and the second length are made shorter than when the travel target point is acquired. Hence, the curvature of the arc can be determined so as to be larger than when the travel target point is acquired. Accordingly, when the vehicle travels through the continuous part, the future travel trajectory of the vehicle can be determined appropriately as a trajectory in which lateral acceleration is suppressed, as in the case of driving by a well-experienced driver.

In another aspect, the travel target point acquisition means preferably acquires the travel target point Xc when the vehicle 3 travels toward the second road 52 while crossing an opposing lane of the first road 51 in the continuous part (intersection 50).

According to the above travel trajectory determination system, the travel target point is acquired when the vehicle travels toward the second road while crossing an opposing lane of the first road in the continuous part. Hence, even under conditions where an oncoming car may travel toward the vehicle in the opposite lane, a location as a target for the vehicle to stop can be set to a location similar to that in the case of driving by a well-experienced driver.

Another aspect of the present disclosure preferably further includes: travel environment detection means (state detection device 4) that detects a travel environment of the vehicle 3; and slope acquisition means (ECU 2, travel environment calculator 10) that acquires a slope at of the second straight line L2 with respect to a straight line perpendicular to the first straight line L1, on the basis of the travel environment (surrounding state data D_info) detected by the travel environment detection means, and the arc determination means preferably determines the arc Ar by use of the slope at.

According to the above travel trajectory determination system, a slope of the second straight line with respect to a straight line perpendicular to the first straight line is acquired on the basis of the travel environment detected by the travel environment detection means, and the arc is determined by use of the slope. Hence, when the future travel trajectory of the vehicle is determined so as to be continuous with a part of the second straight line, the future travel trajectory can be determined such that a part of the second straight line smoothly connects from one end of the arc. Accordingly, the future travel trajectory of the vehicle can be set to an optimal trajectory as in the case of driving by a well-experienced driver.

Another aspect of the present disclosure preferably further includes map data acquisition means (ECU 2) that acquires map data, and when the slope at cannot be acquired on the basis of the travel environment, the slope acquisition means preferably acquires the slope at is preferably acquired by use of the map data.

According to the above travel trajectory determination system, when the slope cannot be acquired on the basis of the travel environment, the slope is acquired by use of map data. Hence, even under conditions where the slope cannot be acquired, the future travel trajectory of the vehicle can be set to an optimal trajectory as in the case of driving by a well-experienced driver.

In another aspect, when the slope at is not acquired by the slope acquisition means, the arc determination means preferably determines the arc Ar by assuming that there is no slope at, and when the slope at is acquired by the slope acquisition means during travel of the vehicle 3 from the first road 51 to the second road 52, the arc determination means preferably determines the arc Ar by use of the slope at acquired by the slope acquisition means.

According to the above travel trajectory determination system, when the slope is not acquired by the slope acquisition means, the arc is determined by assuming that there is no slope. Hence, even when the travel environment of the vehicle cannot be detected by the travel environment detection means, for example, the future travel trajectory of the vehicle can be determined. Additionally, when a slope is acquired by the slope acquisition means during travel of the vehicle from the first road to the second road, the arc is determined by use of the acquired slope. Hence, the future travel trajectory from this point after can be set to an optimal trajectory as in the case of driving by a well-experienced driver.

Another aspect of the present disclosure preferably further includes map data acquisition means (ECU 2) that acquires map data in which a travel trajectory Xf is registered, and when a travel trajectory from the first road 51 to the second road 52 is registered in the map data, the travel trajectory determination means preferably determines the future travel trajectory Xf by reading out the travel trajectory of the map data, and when a travel trajectory Xf from the first road 51 to the second road 52 is not registered in the map data, the travel trajectory determination means preferably determines the future travel trajectory Xf by use of the arc Ar.

According to the above travel trajectory determination system, when a travel trajectory from the first road to the second road is registered in the map data, the future travel trajectory is determined by reading out the travel trajectory of the map data, and when a travel trajectory from the first road to the second road is not registered in the map data, the future travel trajectory is determined by use of the arc. Hence, versatility can be increased as compared to the conventional method in which only read out of a travel trajectory of map data is performed.

One aspect of an automatic driving system according to the present disclosure includes: any one of the above travel trajectory determination systems 1; and steer amount control means (ECU 2, STEPS 61 to 67) that controls a steer amount of the vehicle 3, such that when the vehicle 3 travels from the first road 51 to the second road 52, an error between the future travel trajectory Xf and a trajectory (predicted location Xp) on which the vehicle 3 is assumed to travel in a predetermined period in the future is minimized.

According to the above automatic driving system, for example, the steer amount is controlled such that when the vehicle travels from the first road to the second road, an error between the future travel trajectory and a trajectory on which the vehicle is assumed to travel in a predetermined period in the future is minimized. Hence, when the vehicle makes a right or left turn from the first road toward the second road, a smooth traveling state with no drifting to the right or left as in the case of driving by a well-experienced driver can be ensured. In the above explanation of the exemplary embodiment, specific elements with their reference numerals are indicated by using brackets. These specific elements are presented as mere examples in order to facilitate understanding, and thus, should not be interpreted as any limitation to the accompanying claims.

### BRIEF DESCRIPTION OF THE DRAWINGS

FIG. 1 is a diagram schematically showing a travel trajectory determination system and an automatic driving system of an embodiment of the present disclosure, and a configuration of a vehicle to which the systems are applied.

FIG. 2 is a block diagram showing a functional configuration of the automatic driving system.

FIG. 3 is a block diagram showing a functional configuration of a travel environment calculator.

FIG. 4 is a diagram for describing a determination method of a travel trajectory Xf.

FIG. 5 is a diagram for describing a calculation method of a radius R of an arc used for determination of the travel trajectory Xf.

FIG. 6 is a diagram showing an example of a determination result of the travel trajectory Xf.

FIG. 7 is a diagram for describing a relationship between an evaluation function value J and a signal addition radius R_sk.

FIG. 8 is a diagram for describing a relationship between a movement mean value Pa —1 and the signal addition radius R_sk.

FIG. 9 is a flowchart of travel trajectory determination processing.

FIG. 10 is a flowchart of travel trajectory calculation processing.

FIG. 11 is a flowchart of evaluation function value calculation processing.

FIG. 12 is a flowchart of first evaluation function value calculation processing.

FIG. 13 is a flowchart of automatic driving control processing.

FIG. 14 is a diagram for describing another calculation method of a slope at.

### DETAILED DESCRIPTION

Hereinafter, a travel trajectory determination system and an automatic driving system of an embodiment of the present disclosure will be described with reference to the drawings. Note that since the automatic driving system of the embodiment also serves as a travel trajectory determination system, the following description is given of the automatic driving system, and also includes descriptions of the functions and configuration of the travel trajectory determination system.

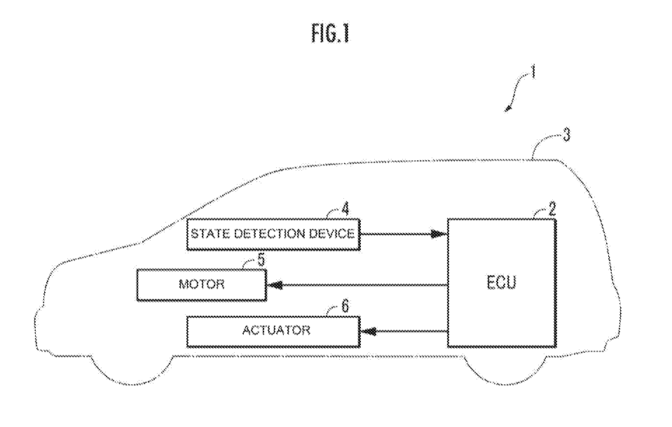

As shown in FIG. 1, an automatic driving system 1 is applied to a four-wheeled vehicle 3, and includes an ECU 2 (Electronic Control Unit). Note that in the following description, the vehicle 3 including the automatic driving system 1 is referred to as “vehicle 3.”

A state detection device 4, a motor 5, and an actuator 6 are electrically connected to the ECU 2. The state detection device 4 (travel environment detection means) is configured of a camera, a millimeter-wave radar, a laser radar, a sonar, a GPS, various sensors, and the like, and outputs surrounding state data D_info (travel environment) indicating the location of the vehicle 3 and the surrounding state (traffic environment, traffic participants, and the like) in the traveling direction of the vehicle 3 to the ECU 2.

As will be described later, the ECU 2 recognizes the location of the vehicle 3 and the surrounding traffic environment of the vehicle 3 on the basis of the surrounding state data D_info from the state detection device 4, and determines a future travel trajectory of the vehicle 3.

The motor 5 is configured of an electric motor, for example, and, as will be described later, when the future travel trajectory of the vehicle 3 is determined, output of the motor 5 is controlled by the ECU 2 so that the vehicle 3 may travel along the travel trajectory.

The actuator 6 is configured of a braking actuator and a steering actuator, for example, and, as will be described later, when the future travel trajectory of the vehicle 3 is determined, operation of the actuator 6 is controlled by the ECU 2 so that the vehicle 3 may travel along the travel trajectory.

Meanwhile, the ECU 2 may be configured of a microcomputer formed of a CPU, a RAM, a ROM, an E2PROM, a map database, an I/O interface, and various electric circuits (none is shown). High-precision map data is stored in the map database, and travel trajectory data is registered in the map data. As will be described later, the ECU 2 performs travel trajectory determination processing and steer amount control on the basis of the surrounding state data D_info and the like from the aforementioned state detection device 4. The ECU may be embodied by ASIC (Application Specific Integrated CIrcuit).

Note that in the embodiment, the ECU 2 corresponds to second road target point acquisition means, arc determination means, travel trajectory determination means, travel target point acquisition means, slope acquisition means, map data acquisition means, and steer amount control means.

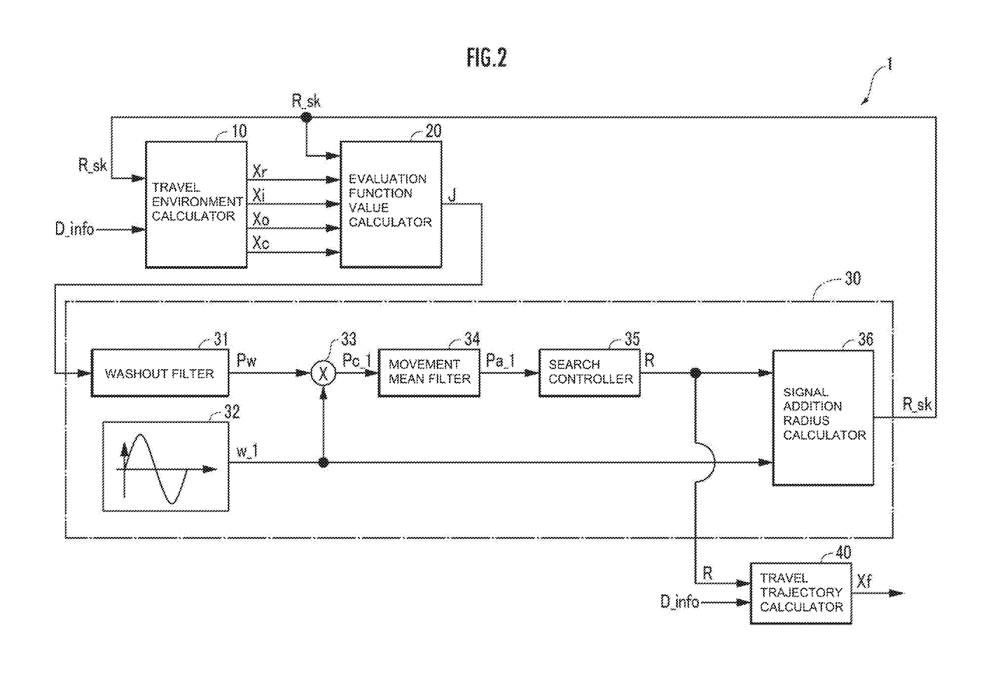

Next, a functional configuration of the automatic driving system 1 of the embodiment will be described with reference to FIG. 2. The automatic driving system 1 calculates a travel trajectory Xf at the time of making a right turn or a left turn at an intersection, for example, according to the following calculation algorithm.

As shown in FIG. 2, the automatic driving system 1 includes a travel environment calculator 10, an evaluation function value calculator 20, a radius calculator 30, and a travel trajectory calculator 40. Specifically, the elements 10, 20, 30, and 40 are configured of the ECU 2.

In the travel environment calculator 10, coordinate values of an incenter Xr of an incircle IC, an entrance side contact point Xi, an exit side contact point Xo, and a travel target point Xc are calculated by use of the surrounding state data D_info and signal addition radius R_sk according to a later-mentioned method. Note that in the embodiment, the travel environment calculator 10 corresponds to the second road target point acquisition means, the travel target point acquisition means, and the slope acquisition means.

Additionally, in the evaluation function value calculator 20, in addition to the coordinate values of the incenter Xr of the incircle IC, the entrance side contact point Xi, the exit side contact point Xo, and the travel target point Xc, an evaluation function value J is calculated by use of the signal addition radius R_sk according to a later-mentioned method. Note that in the embodiment, the evaluation function value calculator 20 corresponds to the arc determination means.

Moreover, in the radius calculator 30, a radius R and the signal addition radius R_sk of the incircle IC are calculated by use of the evaluation function value J according to a later-mentioned method. Note that in the embodiment, the radius calculator 30 corresponds to the arc determination means.

Then, in the travel trajectory calculator 40, coordinate values of the travel trajectory Xf is calculated by use of the radius R of the incircle IC and the surrounding state data D_info according to a later-mentioned method. Note that in the embodiment, the travel trajectory calculator 40 corresponds to the arc determination means and the travel trajectory determination means.

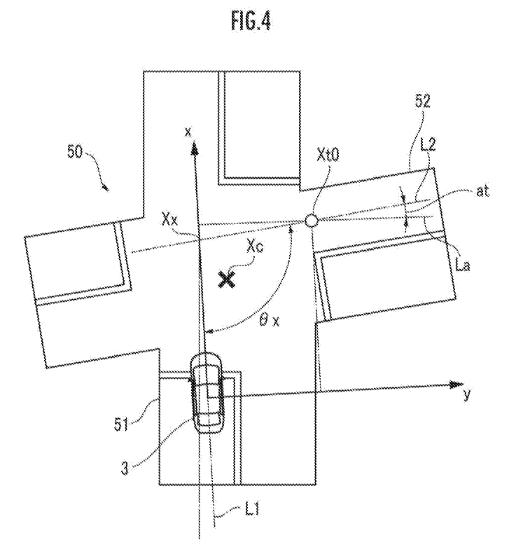

Note that in the following description, first, a calculation method of coordinate values of the travel trajectory Xf at the time of making a right turn at a four-forked intersection 50 (continuous part) shown in FIG. 4 will be described. In this case, relative coordinates of the vehicle 3 are defined by regarding the vicinity of the center of the vehicle 3 as an origin, the traveling direction of the vehicle 3 as the x axis, and a direction perpendicular thereto as the y axis. The x axis coordinate indicates a larger positive value as it proceeds in the traveling direction, and the y axis coordinate indicates a larger positive value as it proceeds in the right direction. Please note that the present embodiment describes the situation of the right turn which is one of typical situations in Japan. In the United States, the situation is “left turn.”

In the following description, a road 51 on which the vehicle 3 is currently traveling before starting the right turn at the intersection 50 is referred to as “first road 51,” and a road 52 into which the vehicle makes the right turn is referred to as “second road 52.” In the example shown in FIG. 4, the traveling direction of the vehicle 3 is slightly sloped with respect to the extending direction of the first road 51.

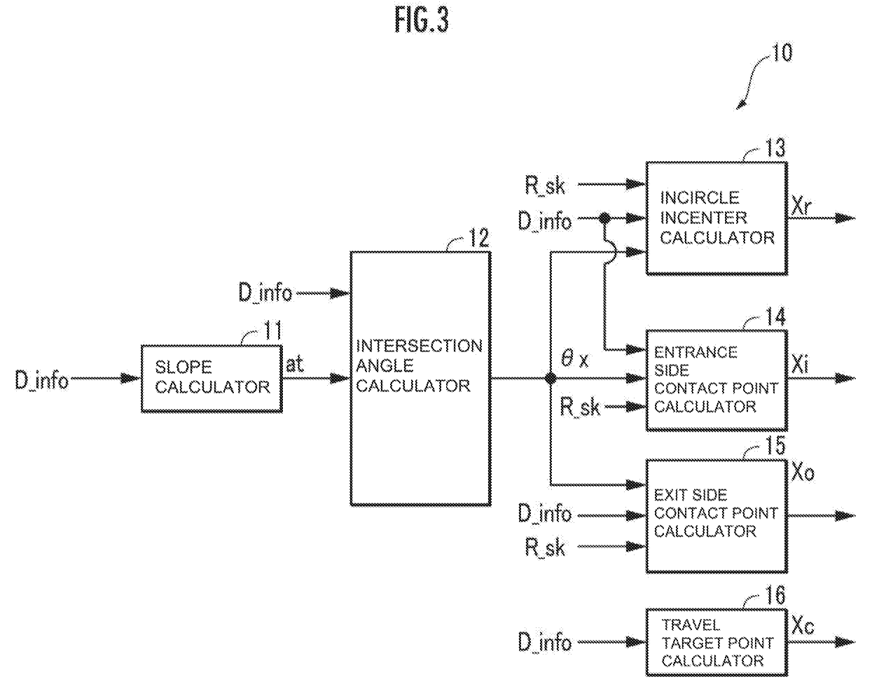

The travel environment calculator 10 calculates coordinate values of the four points Xr, Xi, Xo, and Xc when traveling through the intersection 50, by use of the surrounding state data D_info and the signal addition radius R_sk. As shown in FIG. 3, the travel environment calculator includes a slope calculator 11, an intersection angle calculator 12, an incircle incenter calculator 13, an entrance side contact point calculator 14, an exit side contact point calculator 15, and a travel target point calculator 16.

In the slope calculator 11, a slope at of the second road 52 is calculated in the following manner on the basis of the aforementioned surrounding state data D_info. First, when a control time of discrete data calculated or sampled in a predetermined control cycle ΔT is k, coordinate values (xt0(k), yt0(k)) of a second road target point Xt0 which is a center position (see FIG. 4) of the left lane at the entrance of the second road 52 is calculated on the basis of surrounding state data D_info (k). Note that in the following description, reference sign (k) indicating discrete data is omitted as appropriate.

Next, when aline segment passing through the second road target point Xt0 and having one end perpendicular to the x axis is La, and a straight line passing through the second road target point Xt0, intersecting with the x axis at an intersection Xx, and extending in the extending direction of the second road 52 is a second straight line L2, a slope of the second straight line L2 with respect to the line segment La is calculated as slope at(k).

Next, in the aforementioned intersection angle calculator 12, an intersection angle ex(k) which is an angle between the second straight line L2 and the x axis is calculated in the following manner by use of the slope at(k). First, coordinates (xx(k), 0) of the intersection Xx between the second straight line L2 and the x axis is calculated on the basis of the surrounding state data D_info(k). In this case, since the y coordinate value of the intersection Xx is value 0, only the x coordinate value xx(k) of the intersection Xx is calculated by the following equation (1).

[Expression 1]

xx(k)xt0(k)−at(k)·yt0(k) (1)

The equation (1) is derived in the following manner. First, the second straight line L2 is defined as the following equation (2).

[Expression 2]

x=at·y−xx (2)

By discretizing the equation (2) and substituting the x coordinate value xt0(k) and the y coordinate value yt0(k) of the second road target point Xt0 thereinto, the following equation (3) is obtained. Then, by rearranging equation (3) to make the x coordinate value xx(k) of the intersection Xx the subject, the above equation (1) is derived.

[Expression 3]

xt0(k)=at(k)·yt0(k)+xx(k) (3)

Next, a vector A between the intersection Xx and the origin of the relative coordinates and a vector B between the intersection Xx and the second road target point Xt0 are respectively defined as the following equations (4) and (5). In this case, when a straight line extending along the x axis is a first straight line L1, the length of the vector A corresponds to the length of the first straight line L1 between the intersection Xx and the origin of the relative coordinates, and the length of the vector B corresponds to the length of a part of the second straight line L2 between the intersection Xx and the second road target point Xt0.

$$[ Expression 4 ]$$

$$\begin{matrix}\begin{matrix}A = [ xx ( k ) 0 ] \\ = [ xt 0 ( k ) - at ( k ) \cdot yt 0 ( k ) 0 ]\end{matrix} \\ [ Expression 5 ] & ( 4 ) \\ \begin{matrix}B = [ xt 0 ( k ) - xx ( k ) yt 0 ( k ) ] \\ = [ at ( k ) \cdot yt 0 ( k ) yt 0 ( k ) ]\end{matrix} & ( 5 )\end{matrix}$$

Then, the intersection angle ex which is the angle between the two vectors A and B is finally calculated by the following equation (6).

$$[ Expression 6 ]$$

$$θ x ( k ) = arccos ( \frac{A * B}{\vert A \vert \vert B \vert} ) \qquad ( 6 )$$

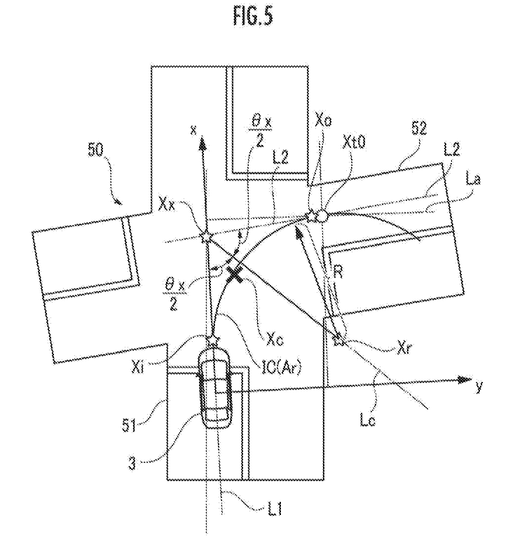

In the aforementioned incircle incenter calculator 13, coordinates (xr(k), y(k)) of the incenter Xr of the incircle IC shown in FIG. 5 are calculated in the following manner. Note that while the radius of the incircle IC is indicated by value R in the case of FIG. 5, in the following calculation algorithm, the signal addition radius R_sk is used instead of the radius R. The reason will be given later.

The incircle IC is inscribed in the aforementioned two straight lines L1, L2 while passing through a point as close as possible to the later-mentioned travel target point Xc. In this case, the incenter Xr of the incircle IC is on a straight line Lc passing through the intersection Xx and extending at a θx/2 angle with respect to the x coordinate axis. Hence, the x coordinate value xr(k) and the y coordinate value yr(k) of the incenter Xr are respectively calculated by the following equations (7) and (8).

$$[ Expression 7 ]$$

$$\begin{matrix}xr ( k ) = xx ( k ) - ( \frac{R\_sk ( k - 1 )}{tan \frac{θ x ( k )}{2}} ) \\ [ Expression 8 ] & ( 7 ) \\ y r ( k ) = R sk ( k - 1 ) & ( 8 )\end{matrix}$$

Moreover, in the aforementioned entrance side contact point calculator 14, an x coordinate value xi(k) and a y coordinate value yi(k) of the entrance side contact point Xi which is a contact point between the incircle IC and the first straight line L1 (i.e., x axis) are respectively calculated by the following equations (9) and (10).

$$[ Expression 9 ]$$

$$\begin{matrix}xi ( k ) = xx ( k ) - ( \frac{R\_sk ( k - 1 )}{tan \frac{θ x ( k )}{2}} ) \\ [ Expression 10 ] & ( 9 ) \\ yi ( k ) = 0 & ( 10 )\end{matrix}$$

Meanwhile, in the aforementioned exit side contact point calculator 15, an x coordinate value xo(k) and a y coordinate value yo(k) of the exit side contact point Xo which is a contact point between the incircle IC and the second straight line L2 are respectively calculated by the following equations (11) and (12).

$$[ Expression 11 ]$$

$$\begin{matrix}xo ( k ) = xr ( k ) + R\_sk ( k - 1 ) \cdot cos ( \frac{π}{2} - θ x ( k ) ) \\ [ Expression 12 ] & ( 11 ) \\ yo ( k ) = y r ( k ) - R\_sk ( k - 1 ) \cdot sin ( \frac{π}{2} - θ x ( k ) ) & ( 12 )\end{matrix}$$

In the aforementioned travel target point calculator 16, an x coordinate value xc(k) and a y coordinate value yc(k) of the travel target point Xc are calculated on the basis of the aforementioned surrounding state data D_info. The travel target point Xc corresponds to a point as a target of where the vehicle 3 should stop in the intersection 50 when there is an oncoming car, and corresponds to a point as a target of where the vehicle should pass at the time of a right turn when there is no oncoming car.

Specifically, the x coordinate value xc(k) and the y coordinate value yc(k) of the travel target point Xc are calculated on the basis of a stop line if there is a stop line in the intersection 50, and is calculated by a deep reinforcement learning method if there is no stop line in the intersection 50.

As has been described, when the vehicle 3 makes a right turn at an intersection, the x coordinate value xc(k) and the y coordinate value yc(k) of the travel target point Xc are calculated by the travel target point calculator 16. On the other hand, when the vehicle 3 makes a left turn at the intersection, the travel target point Xc need not be calculated, so calculation of the x coordinate value xc(k) and the y coordinate value yc (k) of the travel target point Xc is omitted.

Next, the aforementioned evaluation function value calculator 20 will be described. In the evaluation function value calculator 20, the evaluation function value J is calculated according to the following algorithm.

First, a first evaluation function value J1 is calculated by the following equations (13) and (14).

[Expression 13]

Dc(k){square root over ((xe(k)−xr(k))²+(ye(k)−yr(k)))}² (13)

[Expression 14]

J1(k)=WI·(De(k)−R_sk(k−1))² (14)

Here, Dc in equation (13) corresponds to a distance between the incenter Xr of the incircle IC and the travel target point Xc. Additionally, W1 of equation (14) is a first weight coefficient, and is set so that W1>W2>W3>0 holds among later-mentioned second and third weight coefficients W2 and W3. Note that the weight coefficients W1 to W3 may be set so that W1≥W2≥W3≥0 holds.

As is clear from the above equation (14), when a distance between the distance Dc and the signal addition radius R_sk of the incircle IC is regarded as an error, a value obtained by assigning the first weight coefficient W1 to a value corresponding to the squared error is calculated as the first evaluation function value J1.

Additionally, a second evaluation function value J2 is calculated by the following equation (15).

[Expression 15]

J2(k)=W2·{(xo(k)−xt0(k))²−(yo(k)−yt0(k))²} (15)

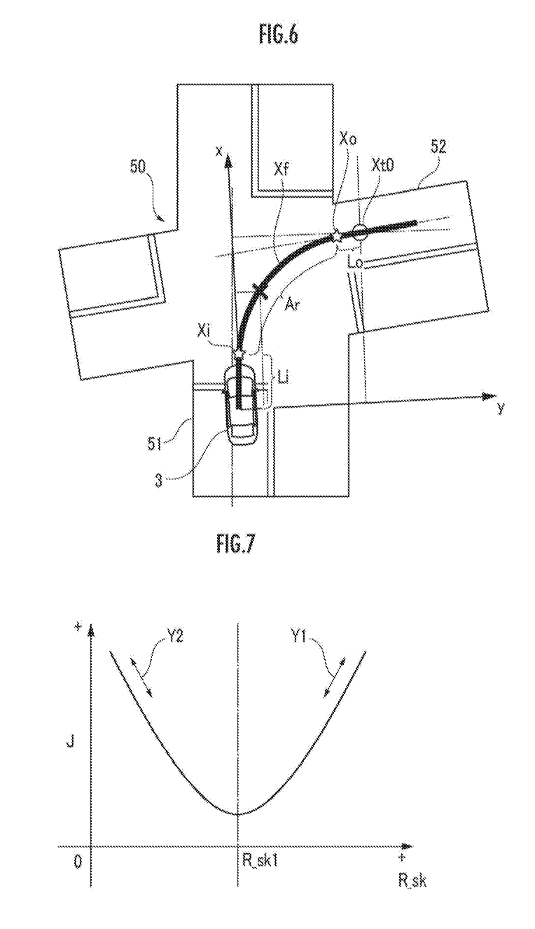

As is clear from the above equation (15), when the length of a line segment Lo (see FIG. 6) from the exit side contact point Xo to the second road target point Xt0 is regarded as an error, a value obtained by assigning the second weight coefficient W2 to a value corresponding to the squared error is calculated as the second evaluation function value J2.

Moreover, a third evaluation function value J3 is calculated by the following equation (16).

[Expression 16]

J3(k)=W3·(xi(k))² (16)

As is clear from the above equation (16), when the length of a line segment Li (see FIG. 6) from the origin of the relative coordinates to the entrance side contact point Xi is regarded as an error, a value obtained by assigning the third weight coefficient W3 to a value corresponding to the squared error is calculated as the third evaluation function value J3.

Then, finally, the evaluation function value J is calculated by the following equation (17).

$$[ Expression 17 ]$$

$$\begin{matrix}J ( k ) = & J 1 ( k ) + J 2 ( k ) + J 3 ( k ) \\ = & W 1 \cdot {( Dc ( k ) - R\_sk ( k - 1 ) )}^{2} + W 2 \{ {( xo ( k ) - xt 0 ( k ) )}^{2} + \\ & {( yo ( k ) - yt 0 ( k ) )}^{2} \} + W 3 \cdot {( xi ( k ) )}^{2}\end{matrix} \qquad ( 17 )$$

As has been described, when the vehicle 3 makes a right turn at an intersection, the evaluation function value J is calculated by use of the calculation algorithm of the equations (13) to (17).

On the other hand, when the vehicle 3 makes a left turn at the intersection, as described earlier, calculation of the x coordinate value xc(k) and the y coordinate value yc(k) of the travel target point Xc is unnecessary. Hence, in the calculation algorithm of the aforementioned equations (13) to (17), the equation (13) for calculating the distance Dc is omitted, and the first evaluation function value J1 in the equations (14) and (17) is set to value 0 to calculate the evaluation function value J. That is, the evaluation function value J is calculated as a sum J2+J3 of the second evaluation function value J2 and the third evaluation function value J3.

Next, the aforementioned radius calculator 30 will be described. The radius calculator 30 calculates the radius R and the signal addition radius R_sk of the incircle IC by use of the evaluation function value J, and, as shown in FIG. 2, includes a washout filter 31, a reference signal generator 32, a multiplier 33, a movement mean filter 34, a search controller 35, and a signal addition radius calculator 36.

In the washout filter 31, a filter value Pw is calculated by the following equation (18).

[Expression 18]

Pw(k)=J(k)−J(k−1) (18)

As shown in the above equation (18), the filter value Pw is calculated as a difference between a current value J(k) and a last value J(k−1) of the evaluation function value. In addition, the washout filter 31 allows passage of a frequency component attributable to a later-mentioned reference signal value w_1 included in the evaluation function value J. In this case, instead of the above equation (18), the filter value Pw may be calculated by a filter algorithm (Butterworth high pass filter algorithm or bandpass filter algorithm) allowing passage of the frequency component of the later-mentioned reference signal value w_1.

Additionally, the reference signal value w_1 is output from the reference signal generator 32. The reference signal value w_1 is set to a periodic function value of a predetermined cycle, and the cycle is set to be a product m·ΔT of a value m (m is a plural number) and a control cycle ΔT. Moreover, examples of the waveform of the periodic function include a sine wave, a cosine wave, a triangular wave, a trapezoidal wave, and a rectangular wave.

Moreover, in the multiplier 33, an intermediate value Pc_1 is calculated by the following equation (19).

[Expression 19]

Pe_1(k)=Pw(k)·w_1(k−1) (19)

In the movement mean filter 34, a movement mean value Pa_1 is calculated by the following equation (20).

$$[ Expression 20 ]$$

$$Pa\_ 1 ( k ) = \frac{1}{1 + m} {\sum }_{r = 0}^{m} Pc\_ 1 ( r ) \qquad ( 20 )$$

The reason of thus setting the number of samplings of the movement mean value Pa_1 to value m+1 is because the frequency component of the reference signal value w_1 is eliminated from the movement mean value Pa_1.

Next, in the search controller 35, the radius R is calculated by a sliding mode control algorithm indicated by the following equations (21) and (22).

[Expression 21]

σ_1(k)=Pa_1(k) S_1·Pa_1(k−1) (21)

[Expression 22]

R(k)=R(k−1)+Ksk_1·σ_1(k) (22)

In the above equation (21), σ_1 is a switching function, and S_1 is a response specification parameter set so that −1<S_{—1<}0 holds. Additionally, in equation (22), Ksk_1 is a predetermined gain. As is clear from the above equations (21) and (22), the radius R is calculated to have a function of converging the movement mean value Pa_1 to value 0 by a sliding mode control algorithm receiving input of an adaptation law alone.

Then, in the signal addition radius calculator 36, the signal addition radius R_sk is calculated by the following equation (23).

[Expression 23]

R_sk(k)=R(k)+w_1(k) (23)

Then, in the travel trajectory calculator 40, a future travel trajectory Xf is calculated as a value shown in FIG. 6 by use of the radius R of the incircle IC and the surrounding state data D_info. That is, the travel trajectory Xf is calculated as a value in which multiple data points (data points formed of an x coordinate value and a y coordinate value) located on a line are associated with a control time k, the line connecting the line segment Li extending from the origin of the relative coordinates to the entrance side contact point Xi, an arc Ar passing through the travel target point Xc (or the vicinity thereof) and extending between the entrance side contact point Xi and the exit side contact point Xo, and the line segment Lo extending from the exit side contact point Xo to the second road target point Xt0.

Next, the principle and reason of calculating the signal addition radius R_sk and the radius R by use of the above calculation algorithm will be described. As mentioned earlier, since the evaluation function value J is calculated as a sum (J1+J2+J3) of the first to third evaluation function values, if the radius R is calculated so as to minimize the evaluation function value J, it is possible to make the distance between the incircle IC, that is, the arc Ar and the travel target point Xc, and the lengths of the aforementioned line segment Li and line segment Lo as short as possible.

In other words, the radius R is calculated such that the arc Ar gradually approaches the travel target point Xc. Additionally, since the aforementioned three weight coefficients W1 to W3 are set so that W1>W2>W3>0 holds, the radius R is calculated such that reduction of the gap between the incircle IC and the travel target point Xc is prioritized over reduction of the aforementioned line segment Li and line segment Lo.

Accordingly, in the case of the embodiment, the following principle is used to calculate the radius R that minimizes the evaluation function value J. First, since the evaluation function value J is calculated by use of the signal addition radius R_sk, the evaluation function value J will show an oscillatory behavior at a predetermined amplitude due to the characteristic (periodic function) of the reference signal value w_1 included in the signal addition radius R_sk.

Here, assuming that the relationship between the signal addition radius R_sk and the evaluation function value J is indicated by a curved line shown in FIG. 7, the oscillatory behavior of the evaluation function value J due to the reference signal value w_1 has a certain slope, as indicated by arrow Y1 or Y2 in FIG. 7. Note that reference sign R_sk1 in FIG. 7 denotes a predetermined value of the signal addition radius. Meanwhile, since the aforementioned movement mean value Pa_1 is a movement mean value which is a product of the filter value Pw of the evaluation function value J and the reference signal value w_1, the movement mean value is a value corresponding to a correlation function of the evaluation function value J and the reference signal value w_1.

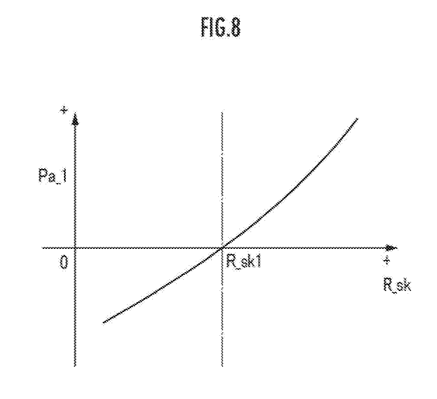

Hence, if the movement mean value Pa_1 corresponding to the correlation function is a positive value, the slope of the evaluation function value J indicates a positive value, and if the movement mean value Pa_1 is a negative value, the slope of the evaluation function value J indicates a negative value. Additionally, since the movement mean value Pa_1 is calculated by the aforementioned equation (20), the movement mean value is calculated with the frequency component of the reference signal value w_1 eliminated. For these reasons, the relationship between the movement mean value Pa_1 and the signal addition radius R_sk is indicated as a monotone increasing function as shown in FIG. 8, for example. That is, the movement mean value Pa_1 indicates the direction in which the evaluation function value J changes when the signal addition radius R_sk is changed.

Accordingly, to calculate the signal addition radius R_sk that minimizes the evaluation function value J, the movement mean value Pa_1 that sets the slope of the function shown in FIG. 8 to value 0 should be calculated. That is, the signal addition radius R_sk should be calculated by use of a feedback control algorithm, so that the movement mean value Pa_1 converges to value 0.

According to the reason described above, in the radius calculator 30 of the embodiment, the signal addition radius R_sk that minimizes the evaluation function value J is calculated by use of the calculation algorithm of equations (18) to (23) including the sliding mode control algorithm [equations (21) and (22)] as a feedback control algorithm.

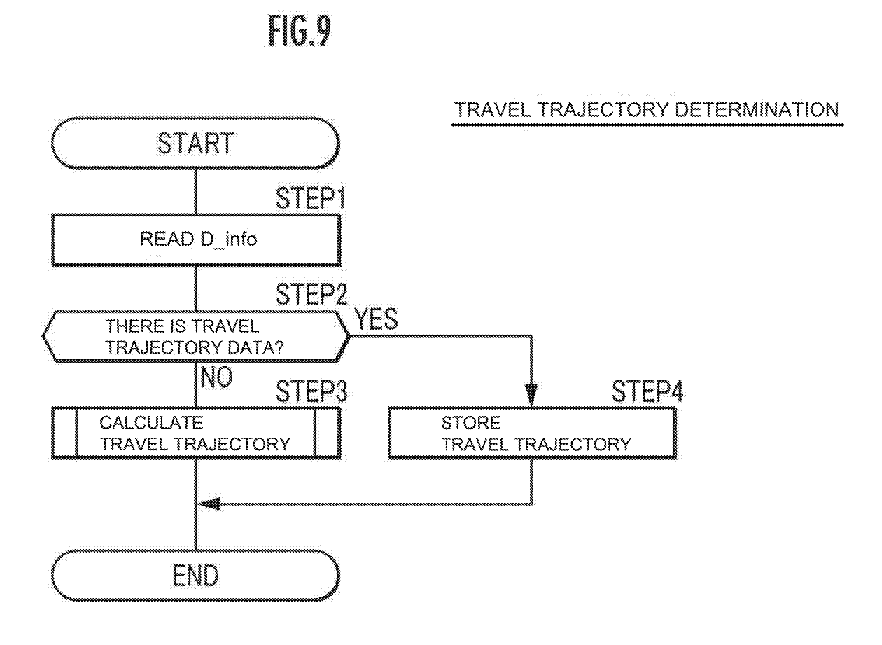

Next, the travel trajectory determination processing will be described with reference to FIG. 9. The travel trajectory determination processing is performed to calculate the future travel trajectory Xf, the evaluation function value J, the signal addition radius R_sk, and the like by the aforementioned calculation method when the vehicle 3 makes a right or left turn at an intersection, and is performed by the ECU 2 at the aforementioned predetermined control cycle AT. Note that the values calculated in the following description are stored in the E2PROM of the ECU 2.

In the travel trajectory determination processing, first, the surrounding state data D_info from the state detection device 4 is read (FIG. 9/STEP 1). The intersection may be identified based on the surrounding state data D_info.

Next, map data inside the map database is consulted to determine whether a travel trajectory of the intersection at which the right or left turn is to be made is registered in the map data (FIG. 9/STEP 2). If the determination is positive (FIG. 9/STEP 2 . . . YES), the travel trajectory in the map data is readout, and is stored in the E2PROM as the travel trajectory Xf (FIG. 9/STEP 4). Then, the processing is terminated.

On the other hand, if the determination is negative, (FIG. 9/STEP 2 . . . NO), that is, if the travel trajectory of the intersection is not registered in the map data, the travel trajectory calculation processing (FIG. 9/STEP 3) described below is performed, and then the processing is terminated.

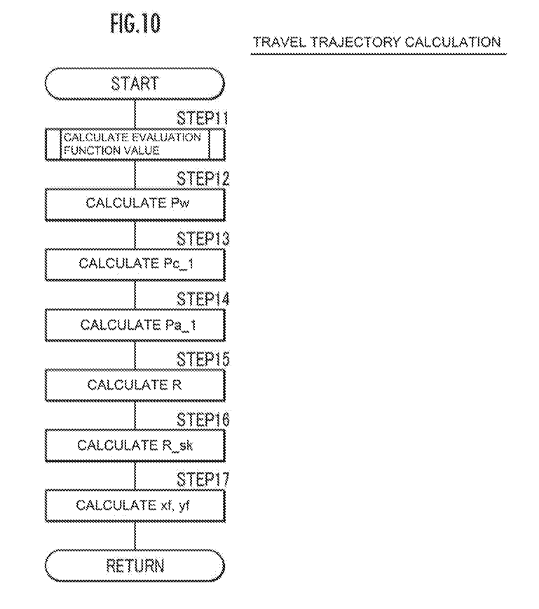

Next, the travel trajectory calculation processing will be described with reference to FIG. 10. In the travel trajectory calculation processing, first, evaluation function value calculation processing is performed (FIG. 10/STEP 11). The evaluation function value calculation processing is performed to calculate the evaluation function value J, and specific descriptions of the processing will be given later.

Next, the filter value Pw is calculated (FIG. 10/STEP 12) by the aforementioned equation (18).

Then, the intermediate value Pc_1 is calculated (FIG. 10/STEP 13) by the aforementioned equation (19), and then the movement mean value Pa_1 is calculated (FIG. 10/STEP 14) by the aforementioned equation (20).

Thereafter, the radius R of the incircle IC is calculated (FIG. 10/STEP 15) by the aforementioned equations (21) and (22), and then the signal addition radius R_sk is calculated (FIG. 10/STEP 16) by the aforementioned equation (23).

Next, many x coordinate values xf and y coordinate values yf in the future travel trajectory Xf are calculated (FIG. 10/STEP 17) by use of the radius R of the incircle IC and the surrounding state data D_info. Then, the processing is terminated.

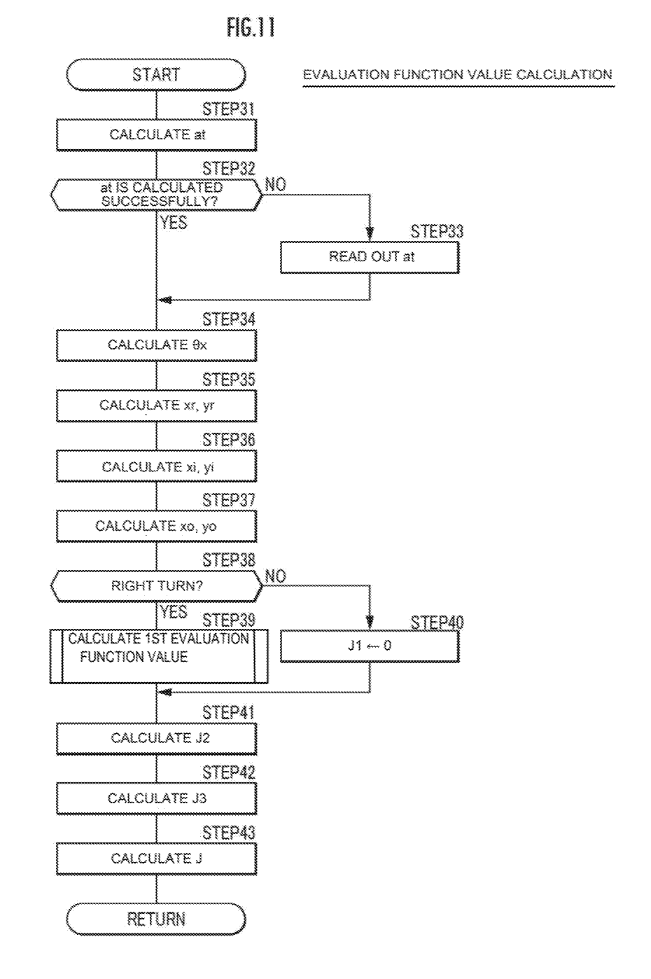

Next, the aforementioned evaluation function value calculation processing will be described with reference to FIG. 11. In the evaluation function value calculation processing, first, the slope at is calculated (FIG. 11/STEP 31) on the basis of the surrounding state data D_info.

Then, it is determined whether calculation of the slope at succeeded (FIG. 11/STEP 32). In this case, sometimes the slope at cannot be calculated depending on the road environment (FIG. 11/STEP 32 . . . NO), and in such a case, the slope at is read out from map data in the database (FIG. 11/STEP 33). Note that if data of the intersection does not exist in the map data in the database, the slope at is read out as value 0.

On the other hand, if calculation of the slope at succeeds (FIG. 11/STEP 32 . . . YES) , or the slope at is read out in the above manner (FIG. 11/STEP 33), thereafter, the intersection angle ex is calculated (FIG. 11/STEP 34) by the aforementioned equations (4) to (6).

Thereafter, the x coordinate value xr and they coordinate value yr of the incenter Xr of the incircle IC are calculated (FIG. 11/STEP 35) by the aforementioned equations (7) and (8), and then the x coordinate value xi and the y coordinate value yi of the entrance side contact point Xi are calculated (FIG. 11/STEP 36) by the aforementioned equations (9) and (10).

Next, the x coordinate value xo and they coordinate value yo of the exit side contact point Xo are calculated (FIG. 11/STEP 37) by the aforementioned equations (11) and (12).

Then, it is determined whether a right turn is being made at the intersection (FIG. 11/STEP 38). If the determination is negative (FIG. 11/STEP 38 . . . NO) , that is, if a left turn is being made at the intersection, the first evaluation function value J1 is set to value 0 (FIG. 11/STEP 40).

On the other hand, if a right turn is being made at the intersection (FIG. 11/STEP 38 . . . YES) , first evaluation function value calculation processing is performed (FIG. 11/STEP 39). The first evaluation function value calculation processing is performed to calculate the first evaluation function value J1, and is specifically performed as shown in FIG. 12.

That is, first, the x coordinate value xc and the y coordinate value yc of the travel target point Xc are calculated (FIG. 12/STEP 51) on the basis of the surrounding state data D_info.

Then, the distance Dc is calculated (FIG. 12/STEP 52) by the aforementioned equation (13).

Next, the first evaluation function value J1 is calculated (FIG. 12/STEP 53) by the aforementioned equation (14). Thereafter, the processing is terminated.

Referring back to FIG. 11, after performing the first evaluation function value calculation processing (FIG. 11/STEP 39) as described above or setting the first evaluation function value J1 to value 0 (FIG. 11/STEP 40) as mentioned earlier, the second evaluation function value J2 is calculated (FIG. 11/STEP 41) by the aforementioned equation (15).

Next, the third evaluation function value J3 is calculated (FIG. 11/STEP 42) by the aforementioned equation (16).

Then, the evaluation function value J is calculated (FIG. 11/STEP 43) by the aforementioned equation (17), and then the processing is terminated.

As has been described, in the automatic driving system 1 of the embodiment, the signal addition radius R_sk is sequentially updated at the predetermined control cycle ΔT, and the signal addition radius R_sk thus updated is used in the next calculation timing to sequentially update the travel trajectory Xf .

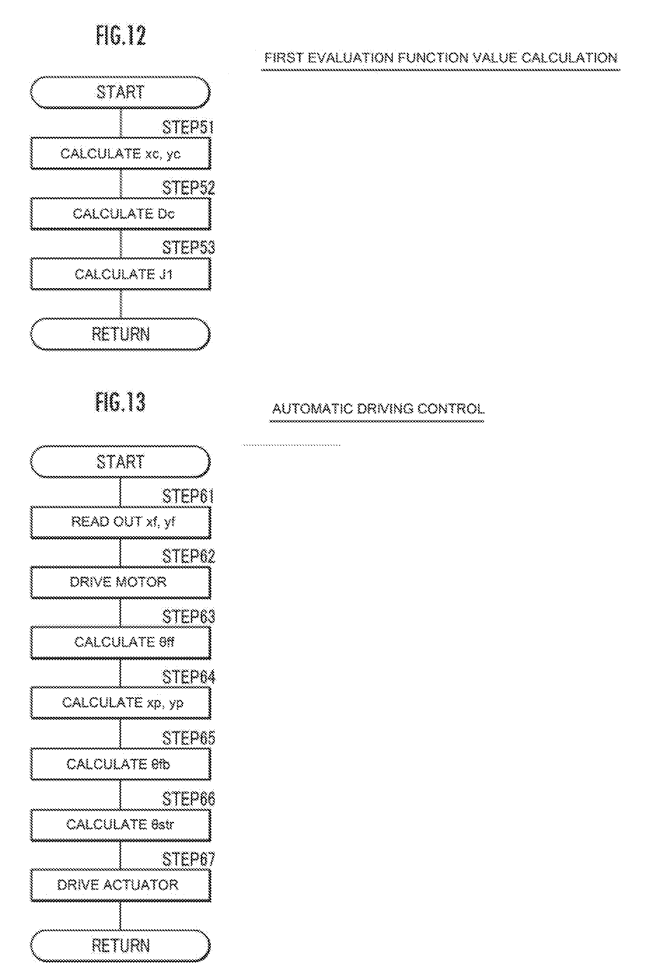

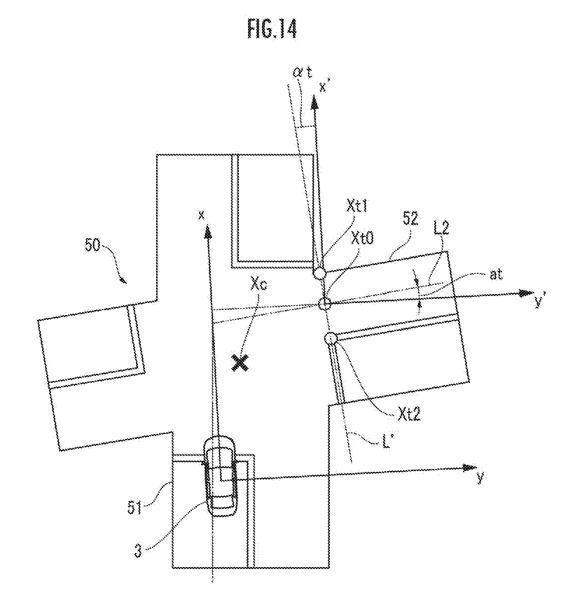

Next, automatic driving control processing will be described with reference to FIG. 13. The automatic driving control processing is performed to control the vehicle 3 so that it travels along the travel trajectory Xf calculated in the aforementioned manner, and is performed by the ECU 2 at a predetermined control cycle ΔTn longer than the aforementioned predetermined control cycle ΔT.

In the automatic driving control processing, first, the x coordinate value xf and the y coordinate value yf of the travel trajectory Xf stored in the E2 PROM are read out (FIG. 13/STEP 61).

Then, the motor 5 is driven on the basis of the x coordinate value xf and the y coordinate value yf of the travel trajectory Xf (FIG. 13/STEP 62).

Next, a feedforward steering angle Off is calculated (FIG. 13/STEP 63) by a predetermined feedforward control algorithm on the basis of the x coordinate value xf and the y coordinate value yf of the travel trajectory Xf.

Thereafter, an x coordinate value xp and a y coordinate value yp of a predicted location Xp are calculated (FIG. 13/STEP 64) by the following equations (24) and (25).

[Expression 24]

xp(n)=Vact(n)·ΔTp·cos φ1(n) (24)

[Expression 25]

yp(n)=Vact(n)·ΔTp·sin φ1(n) (25)

The predicted location Xp is a location at which the vehicle 3 is assumed to arrive after passage of a predetermined time ΔTp from the current point, and Vact in equations (24) and (25) denotes a traveling speed of the vehicle 3, while φ1 denotes a yaw angle of the vehicle 3.

Next, a feedback steering angle efb is calculated (FIG. 13/STEP 65) by an algorithm including a sliding mode control algorithm indicated in the following equations (26) to (31).

$$[ Expression 26 ]$$

$$\begin{matrix}Ey ( n ) = yp ( n ) - yf ( n ) \\ [ Expression 27 ] & ( 26 ) \\ σ ( n ) = Ey ( n ) + S \cdot Ey ( n - 1 ) \\ [ Expression 28 ] & ( 27 ) \\ ufb ( n ) = ufb\_rch ( n ) + ufb\_adp ( n ) \\ [ Expression 29 ] & ( 28 ) \\ ufb\_rch ( n ) = Krch \cdot σ ( n ) \\ [ Expression 30 ] & ( 29 ) \\ ufb\_adp ( n ) = {\sum }_{j = 1}^{k} Kadp \cdot σ ( j ) \\ [ Expression 31 ] & ( 30 ) \\ θ fb ( n ) = Kst \cdot ufb ( n ) & ( 31 )\end{matrix}$$

In the above equation (26), Ey denotes a tracking error. Additionally, in equation (27), σ denotes a switching function, and S is a response specification parameter set so that −1<S<0 holds. Moreover, as shown in equation (28), a feedback control input Ufb is calculated as a sum of a reaching law input Ufb_rch and an adaptation law input Ufb_adp. In equation (29), Krch is a predetermined reaching law gain, in equation (30), Kadp is a predetermined adaptation law gain, and in equation (31), Kst is a sensitivity gain.

Then, a steering angle estr is calculated (FIG. 13/STEP 66) by the following equation (32).

[Expression 32]

θstr(n)=θff(n)+θfb(n) (32)

Next, the actuator 6 is driven according to the steering angle estr (FIG. 13/STEP 67). Thereafter, the processing is terminated.

As has been described, according to the automatic driving system 1 of the embodiment, when the vehicle 3 makes a right turn at the intersection 50, coordinate values of the incenter Xr of the incicrcle IC, the entrance side contact point Xi, the exit side contact point Xo, and the travel target point Xc are calculated by the equations (4) to (12) using the surrounding state data D_info and the signal addition radius R_sk. Based on these pieces of data, the evaluation function value J is calculated by the aforementioned equations (13) to (17). Moreover, the radius R and the signal addition radius R_sk of the incircle IC, that is, the arc Ar, that minimize the evaluation function value J are calculated by the aforementioned equations (18) to (23), and then coordinate values of the future travel trajectory Xf of the vehicle 3 are calculated by use of the radius R, the second road target point Xt0, the entrance side contact point Xi, and the exit side contact point Xo.

Accordingly, the travel trajectory Xf can be determined as a trajectory configured of data located on a curved line that smoothly connects the arc Ar and the two line segments Li and Lo, or a trajectory configured of data located only on the arc Ar. As a result, a smooth trajectory with no drifting to the right or left as in the case of driving by a well-experienced driver, can be determined as the travel trajectory Xf of when the vehicle 3 travels from the first road 51 toward the second road 52 while making a right turn at the intersection 50.

Moreover, since the evaluation function value J is calculated as a sum of the first to third evaluation function values J1 to J3, and the radius R of the arc Ar is calculated so as to minimize the evaluation function value J, the radius R of the arc Ar is calculated such that the arc Ar gradually approaches the travel target point Xc. That is, the travel trajectory Xf can be determined appropriately so that when the vehicle 3 makes aright turn at the intersection 50, the vehicle can stop at (or in the vicinity of) the travel target point Xc and can pass through the travel target point Xc.

Additionally, in the first to third evaluation function values J1 to J3, the three weight coefficients W1 to W3 are set so that W1>W2>W3 holds. Hence, the arc Ar can be determined such that reduction of the distance between the arc Ar and the travel target point Xc is prioritized over reduction of the two line segments Li and Lo, and the arc Ar can be determined such that its curvature is preferentially enlarged. Accordingly, when the vehicle 3 makes a right turn at the intersection 50, a future travel trajectory of the vehicle 3 can be determined appropriately, so that the vehicle can pass through or stop in the vicinity and at the travel target point Xc while suppressing lateral acceleration.

Moreover, when the slope at cannot be calculated on the basis of the surrounding state data D_info, the slope at is acquired by use of the high-precision map data in the map database. Hence, even under conditions where the slope at cannot be acquired, the future travel trajectory Xf of the vehicle 3 can be set to an optimal trajectory as in the case of driving by a well-experienced driver.

Additionally, if the travel trajectory Xf of when a right turn is made at the intersection 50 is registered in the high-precision map data, the future travel trajectory Xf is determined by reading out the travel trajectory Xf of the map data. If the travel trajectory Xf is not registered in the high-precision map data, the travel trajectory Xf is determined in the above manner. Hence, versatility can be increased as compared to the conventional method in which only read out of the travel trajectory Xf of map data is performed.

Moreover, when the vehicle 3 makes a left turn at the intersection, the aforementioned evaluation function value J is calculated as the first evaluation function value J1 =0. Hence, the radius R of the arc Ar can be determined such that the two line segments Li and Lo can be made as short as possible. Accordingly, when the vehicle 3 makes a left turn at the intersection, the future travel trajectory Xf of the vehicle 3 can be determined appropriately while suppressing lateral acceleration.

In addition, the steering angle estr is calculated so as to minimize the error between the travel trajectory Xf of when a right or left turn is made at the intersection 50, and the predicted location Xp where the vehicle 3 is assumed to travel in a predetermined period in the future, and the steering angle estr is used to drive the actuator 6. Hence, when a right or left turn is made at the intersection 50, a smooth traveling state with no drifting to the right or left as in the case of driving by a well-experienced driver can be ensured.

Note that the aforementioned slope at may be calculated in the following manner. First, as shown in FIG. 14, relative coordinate axes relative to the second road target point Xt0 as the origin are defined as an x′ axis and a y′ axis, and when a road end at the entrance of the second road 52 is denoted by point Xt1, and a centerline end at the entrance of the second road 52 is denoted by point Xt2, a straight line L′ extending between the two points Xt1 and Xt2 is set.

Then, when a slope of the straight line L′ with respect to the x′ axis is denoted by αt, y′=αt·x′ holds, and at=1/αt holds for the slope at of the second road 52. In other words, by calculating the slope at with high accuracy, the slope at of the second road 52 can be calculated with high accuracy.

Hence, the slope at is calculated by a regression analysis method. To be specific, x′ coordinate values and y′ coordinate values of multiple points between the two points Xt1 and Xt2 are calculated on the basis of the surrounding state data D_info, these pieces of data are used to calculate the slope at by the method of least squares, and then the slope at is calculated as the inverse of the slope. By calculating the slope at in this manner, the calculation accuracy of the slope at can be improved.

Moreover, if the travel target point Xc is not acquired when a right turn is made at the intersection, the evaluation function value J may be calculated by setting the first evaluation function value J1=0, as in the case of making a left turn at the intersection. In this case, the radius R of the arc Ar can be determined while making the lengths of the two line segments Li and Lo shorter than when the travel target point Xc is acquired. Accordingly, the curvature of the arc Ar can be set larger than when the travel target point Xc is acquired.

Furthermore, in a case where the vehicle 3 does not include a map database, in the aforementioned evaluation function value calculation processing of FIG. 11, if the slope at cannot be calculated on the basis of the surrounding state data D_info, the arc Ar may be calculated by assuming that there is no slope at, and when calculation of the slope at succeeds while making a right or left turn at the intersection, the arc Ar may be determined by use of the calculated slope at. With this configuration, after calculation of the slope at, the future travel trajectory Xf can be set to an optimal trajectory as in the case of driving by a well-experienced driver.

Note that although the embodiment is an example of determining a travel trajectory when a right or left turn is made at a four-forked intersection, the travel trajectory determination of the present invention is not limited to this, and is applicable to any travel trajectory determination when a vehicle travels from a first road toward a second road bending relative thereto. For example, according to the method of the present invention, a travel trajectory may be determined when aright or left turn is made at an L-shaped junction, a T-shaped junction, a three-forked road, or a multiforked road.

Although the embodiment is an example of applying the automatic driving system 1 and the travel trajectory determination system 1 of the present invention to a four-wheeled vehicle, the automatic driving system and the travel trajectory determination system of the present invention are not limited to this, and are also applicable to a two-wheeled vehicle, a three-wheeled vehicle, and a vehicle with five or more wheels.

Although the embodiment is an example in which the steering angle estr is used to control the steer amount of the vehicle 3, the steer amount control method of the present invention is not limited to this, and may be any method as long as the steer amount of the vehicle can be controlled such that an error between the future travel traj ectory and the trajectory on which the vehicle is assumed to travel in a predetermined period in the future is minimized. For example, a temporal variation amount of the steering angle estr, that is, the angular velocity of the steering wheel may be calculated so as to minimize the error between the future travel trajectory and a trajectory on which the vehicle is assumed to travel in a predetermined period in the future, and the steer amount may be controlled by use of the angular velocity of the steering wheel.

Moreover, although the embodiment is an example in which map data acquisition means is configured such that map data is read out from a map database in the ECU 2, the map data acquisition means of the present invention is not limited to this, and may be configured in any way as long as it can acquire map data. For example, map data may be acquired through radio communication. Although a specific form of embodiment has been described above and illustrated in the accompanying drawings in order to be more clearly understood, the above description is made by way of example and not as limiting the scope of the invention defined by the accompanying claims. The scope of the invention is to be determined by the accompanying claims. Various modifications apparent to one of ordinary skill in the art could be made without departing from the scope of the invention. The accompanying claims cover such modifications.

1. A travel trajectory determination system in which a future travel trajectory of a vehicle is determined when the vehicle travels from a first road toward a second road continuous with and bending with respect to the first road, wherein said the first road is continuous with said second road via a continuous part of said first road and said second road, the system comprising:
a second road target point acquisition controller that acquires a second road target point as a target in said second road;
an arc determination controller that determines an arc between two inner contact points of a circle inscribed in a first straight line and a second straight line, said first straight line extending from said vehicle in a traveling direction of the vehicle while passing through said continuous part of said first road and said second road, and said second straight line extending in such a manner as to intersect with the first straight line in said continuous part while passing through said second road target point, the arc determination controller determining the arc such that the arc is at least included in said continuous part; and
a travel trajectory determination controller that determines said future travel trajectory of said vehicle by use of the arc.

2. The travel trajectory determination system according to claim 1 further comprising a travel target point acquisition controller that acquires a travel target point as a target when said vehicle stops in said continuous part or passes through the continuous part, wherein
said arc determination controller determines said arc such that said arc gradually approaches said travel target point.

3. The travel trajectory determination system according to claim 1 further comprising a travel target point acquisition controller that acquires a travel target point as a target when said vehicle stops in said continuous part or passes through the continuous part, wherein
said arc determination controller determines said arc such that, with respect to (i) a distance between said arc and said travel target point, (ii)a first length which is a length of said first straight line from said vehicle to said inner contact point of said arc, and (iii) a second length which is a length of said second straight line from said inner contact point of said arc to said second road target point, reduction of said distance is prioritized over reduction of said first length and said second length.

4. The travel trajectory determination system according to claim 3, wherein
in a case where said vehicle travels from said first road toward said second road, when said travel target point cannot be acquired by said travel target point acquisition controller, said arc determination controller determines said arc such that said first length and said second length are made shorter than when said travel target point is acquired.

5. The travel trajectory determination system according to claim 2, wherein
said travel target point acquisition controller acquires said travel target point in a case that said vehicle travels toward said second road while crossing an opposing lane of said first road in said continuous part.

6. The travel trajectory determination system according to claim 1 further comprising:
a travel environment detection controller that detects a travel environment of said vehicle; and
a slope acquisition controller that acquires a slope of said second straight line with respect to a straight line perpendicular to said first straight line, on the basis of the travel environment detected by the travel environment detection controller, wherein
said arc determination controller determines said arc by use of said slope.

7. The travel trajectory determination system according to claim 6 further comprising a map data acquisition controller that acquires map data, wherein
when said slope cannot be acquired on the basis of said travel environment, said slope acquisition controller acquires said slope by use of said map data.

8. The travel trajectory determination system according to claim 6, wherein
when said slope is not acquired by said slope acquisition controller, said arc determination controller determines said arc by assuming that there is no slope, and when said slope is acquired by said slope acquisition controller during travel of said vehicle from said first road to said second road, said arc determination controller determines said arc by use of the slope acquired by the slope acquisition controller.

9. The travel trajectory determination system according to claim 1 further comprising a map data acquisition controller that acquires map data in which a travel trajectory is registered, wherein
when a travel trajectory from said first road to said second road is registered in said map data, said travel trajectory determination controller determines said future travel trajectory by reading out the travel trajectory of the map data, and when a travel trajectory from said first road to said second road is not registered in said map data, said travel trajectory determination controller determines said future travel trajectory by use of said arc.

10. An automatic driving system comprising:
the travel trajectory determination system according to claim 1; and
a steer amount controller that controls a steer amount of said vehicle, such that when said vehicle travels from said first road to said second road, an error between said future travel trajectory and a trajectory on which the vehicle is assumed to travel in a predetermined period in the future is minimized.

11. The travel trajectory determination system according to claim 1, wherein said vehicle is a host vehicle equipped with the travel trajectory determination system.

12. The travel trajectory determination system according to claim 1, wherein the traveling direction of the vehicle is a current traveling direction of the vehicle in the first road.

13. The travel trajectory determination system according to claim 3, wherein said first length is a length of said first straight line from a current position of said vehicle to said inner contact point of said arc.

14. The travel trajectory determination system according to claim 1, wherein said second straight line extends along an extending direction of the second road.

15. A travel trajectory determination method in which a future travel trajectory of a vehicle is determined when the vehicle travels from a first road toward a second road continuous with and bending with respect to the first road, wherein said the first road is continuous with said second road via a continuous part of said first road and said second road, the method comprising steps of:
acquiring, by a computer, a second road target point as a target in said second road;
determining, by the computer, an arc between two inner contact points of a circle inscribed in a first straight line and a second straight line, said first straight line extending from said vehicle in a traveling direction of the vehicle while passing through said continuous part of said first road and said second road, and said second straight line extending in such a manner as to intersect with the first straight line in said continuous part while passing through said second road target point, and determining the arc such that the arc is at least included in said continuous part; and
determining said future travel trajectory of said vehicle by use of the arc.
